(19) United States
(12) Patent Application Publication
(10) Pub. No.: US 2009/0238616 A1
(43) Pub. Date: Sep. 24, 2009

(54) ULTRA-LOW COLOR DENSITY PRINT FINISHING SYSTEM WITH HIGH GLOSS FOR IMAGE HIGHLIGHTING

(76) Inventor: Andrew Ciaschi, Pittsford, NY (US)

Correspondence Address: EASTMAN KODAK COMPANY;PATENT LEGAL STAFF, 343 STATE STREET, ROCHESTER, NY, 14650-2201, US

(21) Appl. No.: 12/051,360

(22) Filed: Mar. 19, 2008

(51) Int. Cl. G03G 15/20

(52) U.S. Cl. 399/341

(57) ABSTRACT

A printing system and more specifically a printing system with a finishing system that is capable of printing with some specified level of gloss with a color hue in one or more areas of a final product using a clear toner in combination with a very low color density pigmented toner screen pattern to produce glossy areas, for example watermarks, glossy highlighted patterns, or glossy images of any sort, with a slight color hue.

### FIELD OF THE INVENTION

This invention relates in general to controlling gloss in a printing system and more specifically to controlling gloss having a color hue. The printing system further includes a finishing system that is capable of printing with some specified level of gloss with a color hue in one or more areas of the final product.

### BACKGROUND OF THE INVENTION

Printing, such as electrophotography (EP), has become more and more capable of reproducing pictorial subject matter, especially in three or four colors in addition to a clear toner so that now users often desire to print textural material, graphics and/or pictorial subject matter. Users of office copiers and printers have an increasing demand for a combination of text and photo quality images in one print. Users are also demanding results similar to those achieved by professional print shops. Professional print shops produce documents such as brochures, certificates, pamphlets, and the like with spot gloss or spot varnish gloss with a color hue. This treatment can be a regional or image-wise coating of clear ink or toner.

In addition new printers have scanners associated with them to enhance functionality. These All-in-One printers have created the need for on-demand finishing functionality along with the development of a more energy efficient, quicker starting, lower cost, and more reliable fusing processes, that can deliver both quality text and proper image quality.

To meet the proper image quality in today's market, control of the image gloss, luster and other surface finishes has become more important. A user selectable gloss level and coverage in association with a specific color hue is also needed to satisfy end user demands. This is especially apparent when using a special need print, such as one including a watermark.

### SUMMARY OF THE INVENTION

This invention is directed to a method of controlling gloss and differential gloss in a printing system and more specifically to controlling gloss and differential gloss having a color hue. The printing system further includes a finishing system that is capable of printing with some specified level of gloss with a color hue in one or more areas of a final product using a clear toner in combination with a very low color density toner screen pattern to produce glossy areas, for example watermarks (with a slight color hue), glossy highlighted patterns, or glossy images of any sort. For dramatic effects a large intentional differential gloss (or gloss contrast) can also be applied to specific areas of a page (e.g. glossy watermark with matte images and text).

### BRIEF DESCRIPTION OF THE DRAWINGS

FIG. 1 shows an All-in-One, multifunction printer.

FIG. 2 shows a printer with finishing system(s) for gloss control.

FIG. 3 shows a schematic sketch of a paper path through a printing device according to the present invention.

FIG. 4 shows methods for controlling differential gloss on glossy coated paper according to one embodiment of the present invention.

FIG. 5 shows methods for controlling differential gloss on matte coated paper according to one embodiment of the present invention.

FIG. 6 shows a graph illustrating the exemplary amount of clear ink to be used versus the amount of color toner to achieve image features according to the present invention.

FIG. 7 shows a graph illustrating a toner color density scale with respect to toner mass percent coverage according to the present invention.

FIG. 8 shows a schematic of one embodiment of the present invention including a fusing system that utilizes a substrate pre-heater.

FIG. 9 shows a graph illustrating apparent color density with respect to % toner coverage.

FIG. 10 shows a method according to one embodiment of the present invention for basic spot gloss.

FIG. 11 shows a method according to one embodiment of the present invention for image enhancement.

### DETAILED DESCRIPTION OF THE INVENTION

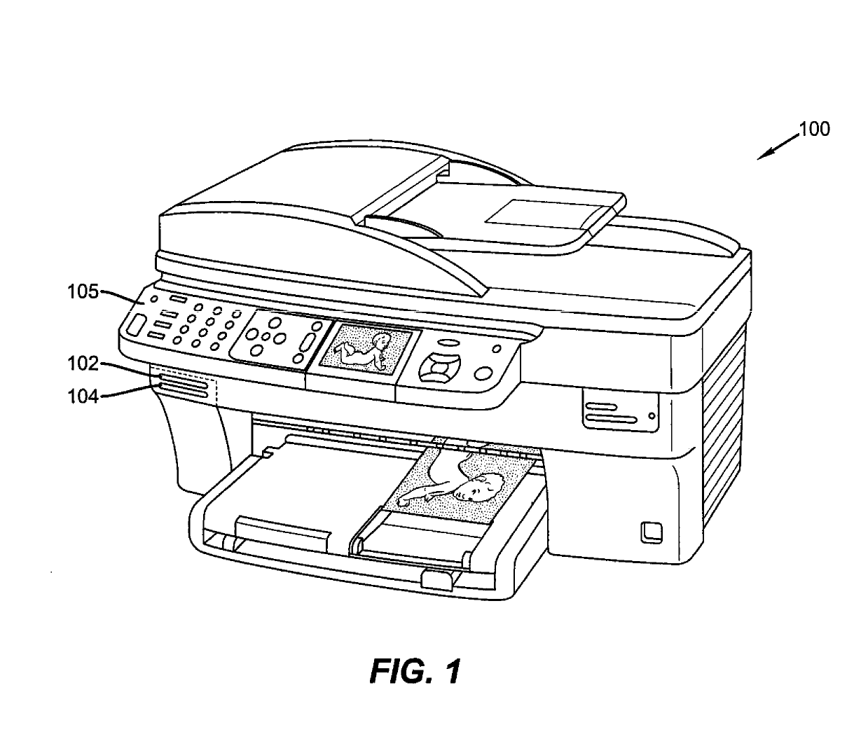

FIG. 1 shows the on-demand printing system 100, such as an all-in-one printer, including an image detection device 102 and a gloss detection device 104. Such an all-in-one printer and scanner would be similar to an “All-In-One” product such as the Eastman Kodak Series (5500), which provides integrated printing, faxing, scanning and copying functions, all in color. The printer/scanner system includes a circuit card with firmware 105 (shown with dashed lines). Algorithms utilized by the printing system, including the image detection device 102 and the gloss detection device 104 controls, can be stored in the firmware 105. It should be understood that other system configurations can be employed. The on-demand printing system 100 includes scanning functionality and equipment as well as printer functionality and equipment in one integrated unit. Such integration can be physical, where the scanner and printer hardware are mechanically attached to each other. Or, it can be a virtual integration where the scanning unit and the printer unit are logically attached by wires, a network, or wireless network, and software.

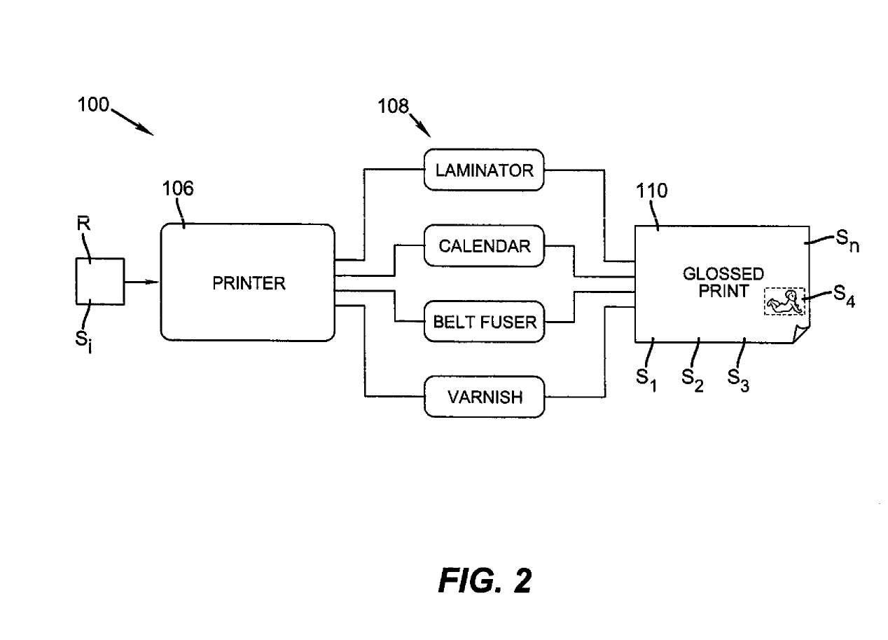

FIG. 2 shows on-demand printing system 100 with finishing capabilities, including printing with some specified level of gloss, such as differential gloss, with a color hue, also referred to as colored differential gloss. Those skilled in the art understand that there are many means of achieving a specified level of differential gloss including, but not limited to, overcoats or varnishes applied after printing, calender or reflowing toner in a ferrotyping step after printing, laminating a clear overcoat with a particular gloss level and finishing the print in such as way that the gloss matches a desired differential gloss level. In the on-demand printing system a receiver R enters the printer 106 having a surface Si. The receiver may be an unprinted receiver, such as plain paper, or may already have print such as text or pictorial images. The finishing device 108 can use a variety of methods to finish the receiver after printing, as described above, to produce a surface S1,2,3,4,n on print 110.

Professional print shops produce documents, such as brochures, certificates, pamphlets, and the like with spot gloss or spot varnish. This treatment can be a regional or image-wise coating of clear ink or toner. Clear ink or toner can also be printed as a watermark such as a single or repeating phrase of logo that is barely visible on the document and appears as a an area or pattern of increased differential gloss relative to the unprinted area of the document as described in U.S. Pat. No. 7,228,006 entitled Method and system for detecting a geometrically transformed copy of an image and U.S. Pat. No. 6,888,647 entitled Proofing with watermark information created by a raster imaging processor. With the advent of a 5th station and clear toner in on-demand printing systems such as the Kodak NexPress 2500, it is now possible to add digitally addressable spot differential gloss to individual documents.

Multi function printers (MFP) are discussed in this description and include both scanning and printing functionality and equipment in one integrated unit. The integrated printer and scanning functionality can be physical, such that the printing systems the scanner and printer hardware are mechanically attached to each other. Alternatively the printing system can be a standalone printer that does not include a scanner.

The marking engine of the MFP system can be toner or ink jet based. One type of marking engine is an electrophotographic (EP) printer that uses EP toner. Toner is meant to include many types of marking materials including pigmented toner and dye based toners as well as other toner with and without a color. Typically, the image data file is processed by an image writing unit and printed onto receiver sheets that are picked by a paper handing unit, sometimes referred to as a paper picking unit, from a tray in the MFP all under control of a Central Control Unit [CCU]. In most MFP systems such printing is done with no regard for the gloss characteristics of the original or the receiver sheets resulting in copies of the original that do not reproduce the gloss level of the original.

In such systems featuring a scanner and printer, a major application is the copying of documents. This is done by first scanning the document using the scanning function. This may be a single page scan, usually done using a flat bed scanner or a multi-page scan, usually done using an automated document feeder (ADF). Then the scanned document is converted into digital data that can be used to produce a replica of the original document. Such copies are limited today to replicate the image content information. Other qualities of the original, such as the gloss of the original document, are not reproduced. This results in customer dissatisfaction because image gloss is an important component of the overall document's appearance.

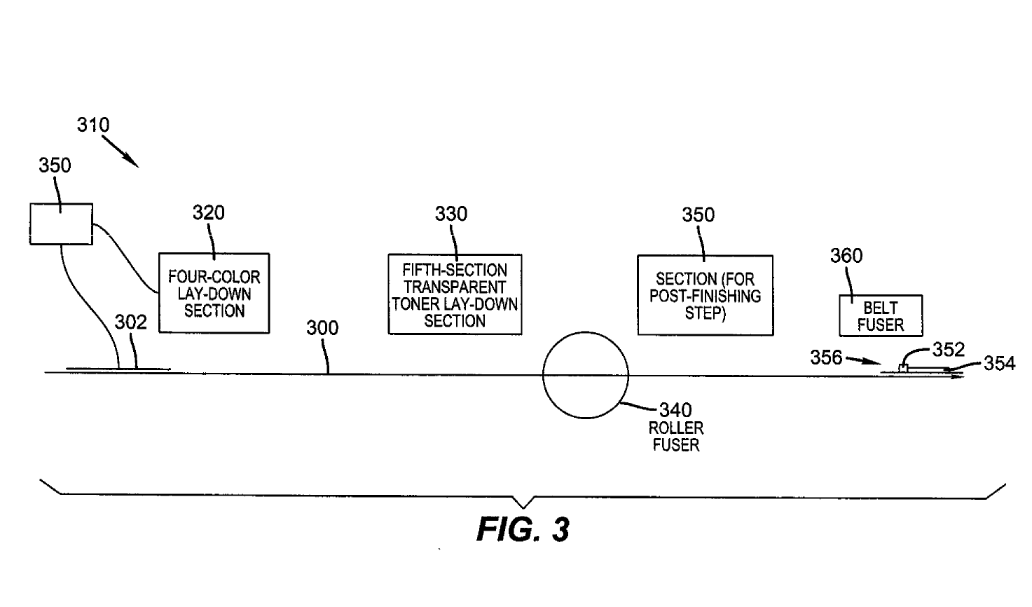

FIG. 3 shows a schematic sketch of a paper path through a printing device according to the present invention. Referring to FIG. 3, there is shown a schematic sketch of a paper path 300 through a printing device 310 according to the present invention. Along paper path 300 there may be disposed a four-color toner lay-down section 320 for laying colored toner onto a substrate 302 to form an image. Next, along paper path 300, there may be disposed a fifth section, transparent toner lay-down section 330, for laying down transparent toner onto substrate 302 and toner image. Once transparent toner is laid down, the substrate 302 may be fused with a contact fuser 340 to produce a fused image, with a specified differential gloss and mean gloss

This method for controlling gloss and/or differential gloss of a printed image includes determining pigmented toner type, transparent toner type and media type, also referred to as gloss input data to determine a final desired gloss 352 and/or a differential gloss of a fused image 354 before applying a small amount of pigmented toner to produce a low-color-density image from the four-color lay-down section 320 onto the media of the media type to form an image 356. The transparent toner is applied over at least a portion of the media substrate including the image 356 and fusing said image to form the fused image or print having the final desired gloss and the differential gloss of a fused image.

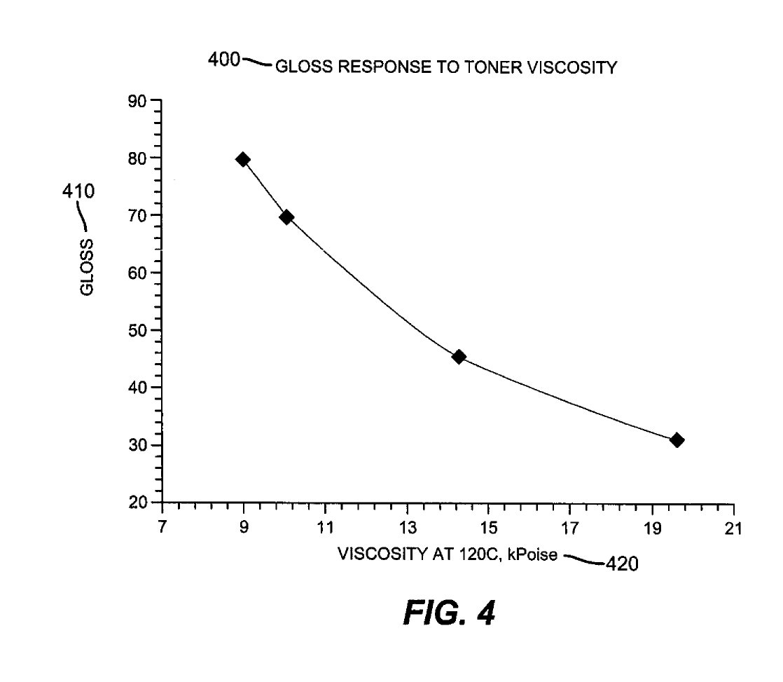

To control the gloss of a special mark such as a watermark the melt flow and solidification properties of the toner can be used as a control factor. The melt viscosity can be chosen based on the amount of contrast desired with the dominant marked images. For example: a gloss contrast of 30 units is desired between the dominant images and a watermark with a slight magenta hue: where the watermark has the higher gloss of the two. One can use a higher viscosity toner, around 16 kPoise for the colors, and a lower viscosity clear toner, around 10 kPoise for the watermark. FIG. 4 shows a graph that shows a gloss response curve 400, having gloss units 410, with respect to toner viscosity 420. It is clear from the graph that the lower the melt viscosity the higher the gloss capability. This property can be exploited to produce a particular gloss contrast. Melt viscosities as low as 2 kPoise can produce high gloss in roller and film type fusers and melt viscosities as high as 200 kPoise can produce very low levels of gloss.

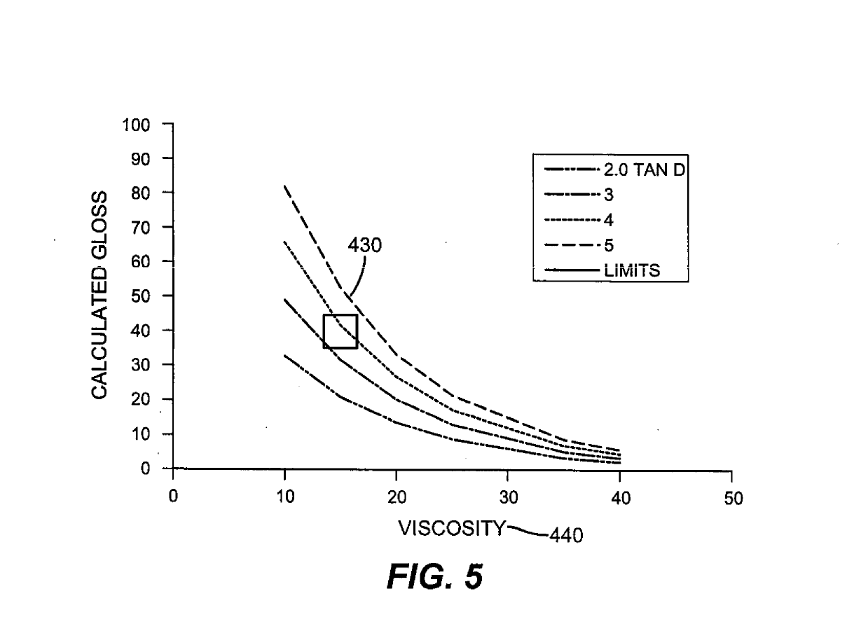

Viscoelastic properties that also influence the final gloss product are typically described by the property ratio tan δ. Tan δ is a ratio of the storage modulus (elastic modulus) and the loss modulus (viscous modulus), FIG. 5 shows gloss response curves 430 to toner melt viscosity 440, at four different tan δ values. As tan δ increases the gloss response curve increases. This property is important with respect to the fusing process time, also known as the fusing dwell. This property indicates the amount elastic rebound that will take place post fusing. The more rebound the lower the gloss response. In other terms, if the relaxation time of the toner is smaller than the fusing dwell, then there will be more viscous dissipation and less rebound, resulting in a higher gloss response.

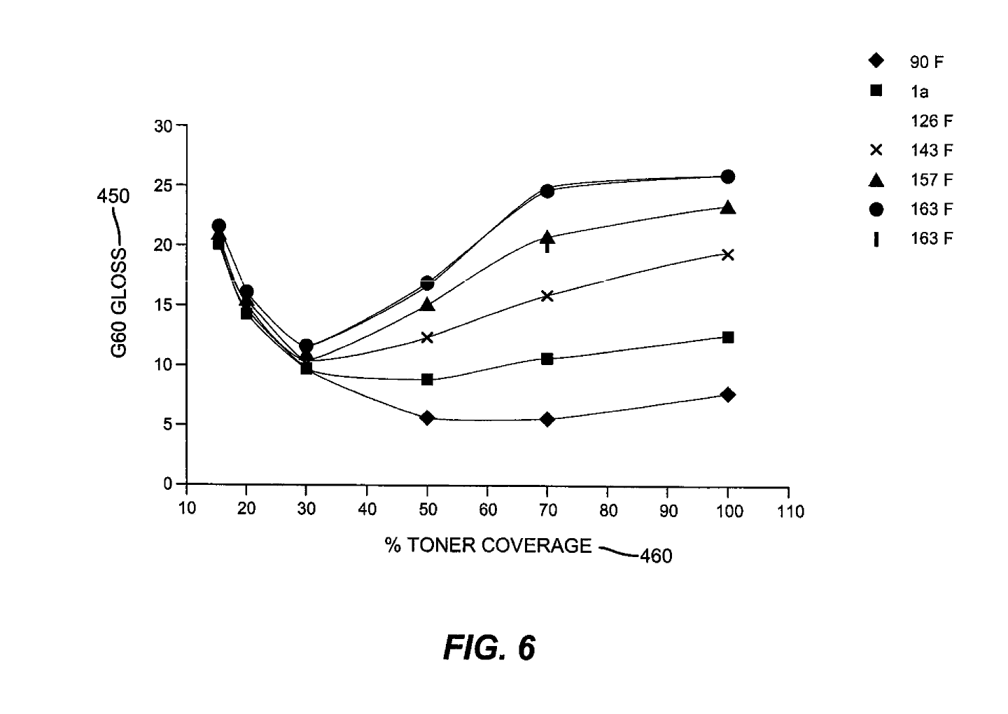

In addition to using a specific set a viscosities to control the gloss contrast, toner area mass lay-down can be used. In general, as the toner area mass lay-down increases the gloss response increases. At low area mass lay-downs, less than 100% coverage, the scattered toner particles do not form a continuous film, after being sintered and glossed (or fused). FIG. 6 shows a toner gloss (G60 Gloss) response 450 to toner percent coverage 460. The substrate gloss, in this case, was around 25 G60 Gloss Units. Once the 100% coverage level has been attained there is nearly a continuous film of toner, and the gloss begins to exceed the substrate gloss. But, when the toner film is still thin the substrate surface roughness still has influence. As the toner layer gets thicker, the substrate influence decreases and the gloss rises: the amount is based on the melt flow and solidification properties of the toner (melt viscosity and viscoelastic properties).

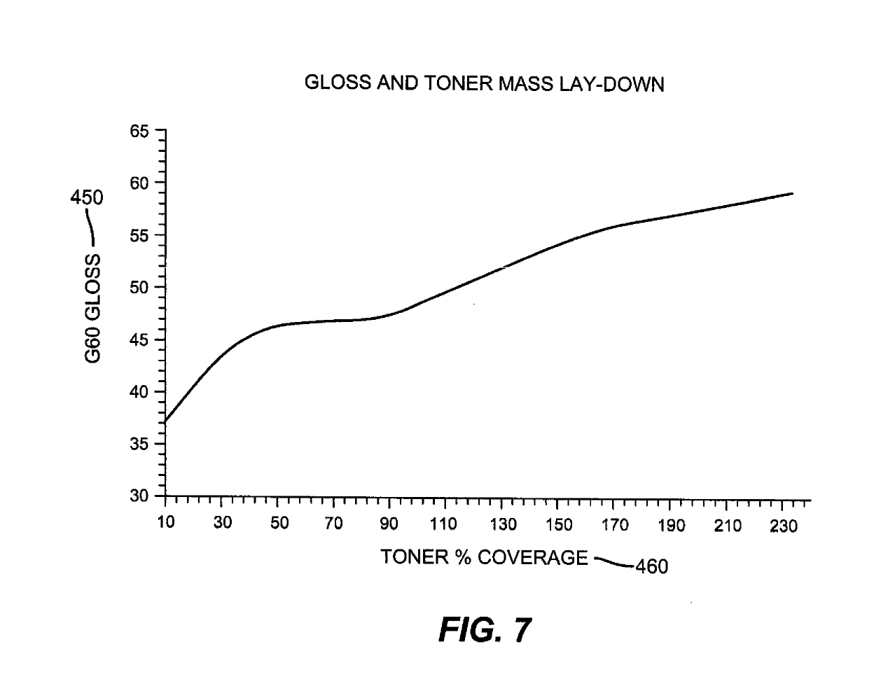

FIG. 7 shows a gloss response 450 from 10% toner coverage to approximately 230% toner coverage. In this case the substrate gloss was around 45, and it can be seen that the gloss continues to increase above the paper gloss at Toner % Coverage greater than approximately 100%.

In conjunction with the toner properties and the toner area mass lay-down, the fusing process and operating set-points can produce a variety of gloss contrast levels. This allows the toner properties to be designed for the fusing process. Defining the fusing process and toner properties then set the possible operating window for gloss response with respect to each of the five toners: four primary colors and a clear (or transparent). This leaves the fuser operating set-points and the toner mass lay-down scheme to gain control over the gloss response for a certain desired (or specified) range with a specific fusing system and toner material set.

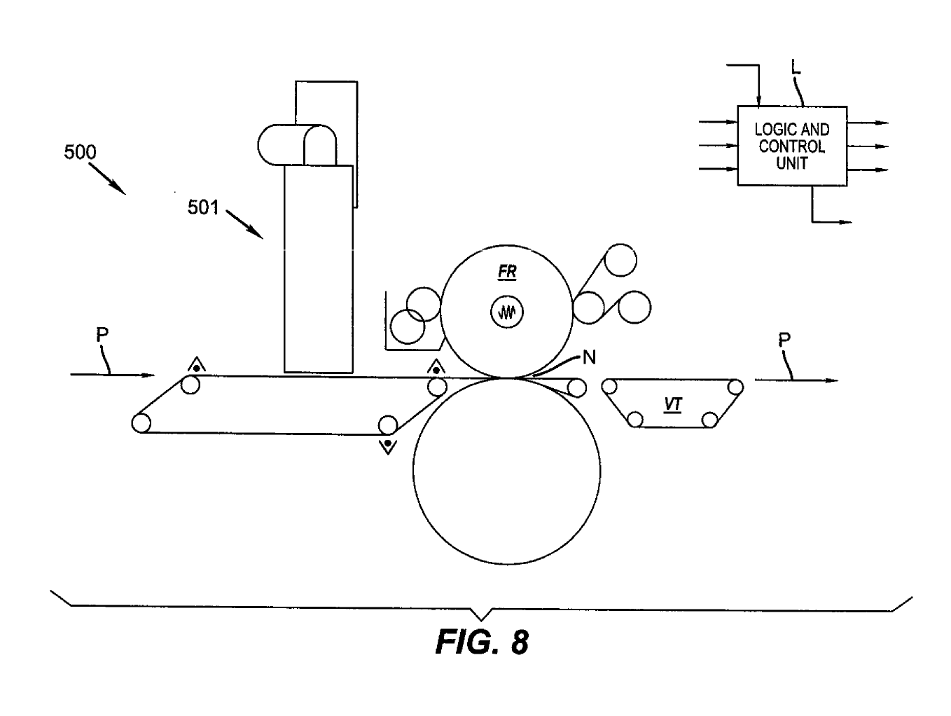

Referring back to FIG. 6 that shows that a defined fusing process and a defined set of toner properties can produce the family of gloss curves based on the substrate initial temperature. This particular fusing process uses a substrate pre-heater to heat the substrate (to different initial temperatures) before it enters a contact fuser, as laid open in U.S. Pat. No. 6,754,457. FIG. 8 shows a fusing system 500 that utilizes a substrate pre-heater 501. FIG. 6 shows that tuning the substrate initial temperature (a fuser operating set-point) can effect a 17 unit change in gloss with respect to % Toner Coverage. In this same manner fusing surface temperature, fusing nip pressure profile, and process velocity can affect a gloss response, including a desired gloss contrast.

To achieve a high gloss a low viscosity toner with a toner area coverage greater than or equal to 100% can be used. This gloss can be placed locally, in a spot wise fashion, for an accentuated gloss contrast. This can be done with clear toner directly deposited onto the substrate, or it can be deposited over a stack of color toner. When deposited onto a stack of color toner, the clear toner may be deposited with an inverse mask that levels the height of the toner stack to the maximum level of the color toner, or it can be deposited in a uniform thickness (following the topography of the color toner stacks). Using the inverse mask can reduce the toner usage as long as the intended effects are achieved. The inverse mask may also be needed if fusing power is constrained. With higher toner stacks more energy is needed due to the increased thermal mass: therefore an inverse mask can maintain the smallest possible toner stack height for manipulating the gloss response.

When depositing clear toner particles in a uniformly thick layer over pigmented toner particles, varying the layer thickness (also known as stack height, which is directly proportional to area mass lay-down and toner % coverage) of the clear toner particles can modulate the gloss response. The gloss response shape will still behave in the manner shown in FIG. 6. From the minimum % coverage to around 10% toner coverage, in this case, the pigmented toner gloss response will dominate. From approximately 10% to 30% the gloss response, due to the scattered clear toner particles, will cause the reflected light to scatter resulting in a lower gloss with respect to the gloss response of the pigmented toner. This will generate an area of lower gloss (or de-glossing).

In the case of a 163° F. initial temperature, shown in FIG. 6, the gloss minimum is near 30% Toner Coverage. From that point to around 60% coverage the gloss rises to nearly match the substrate gloss (of around 25). This behavior can be used to have nearly matching gloss, or virtually no differential gloss within the image and between the substrate and the image.

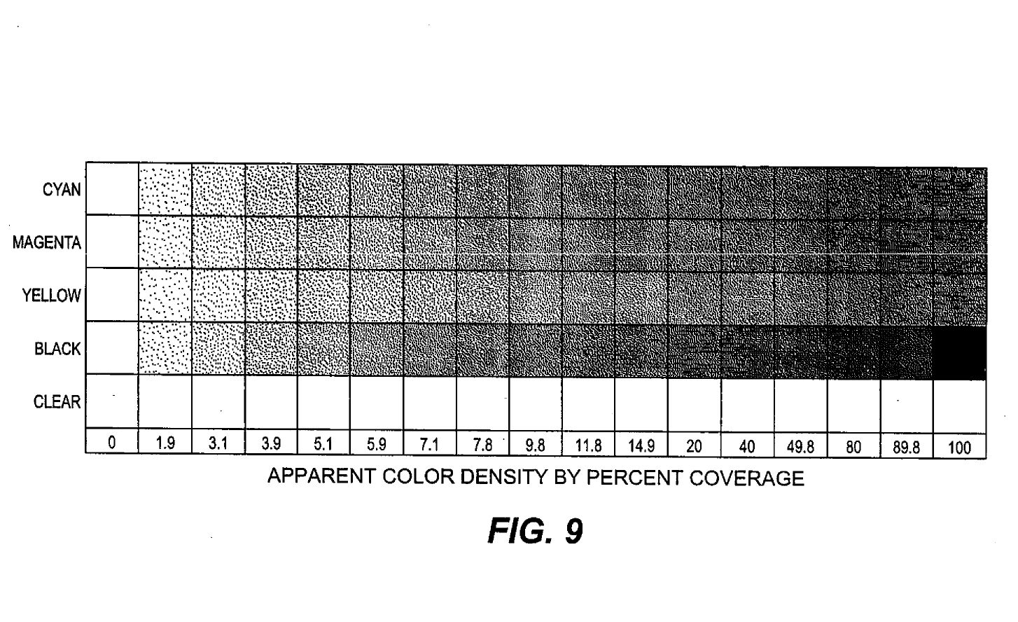

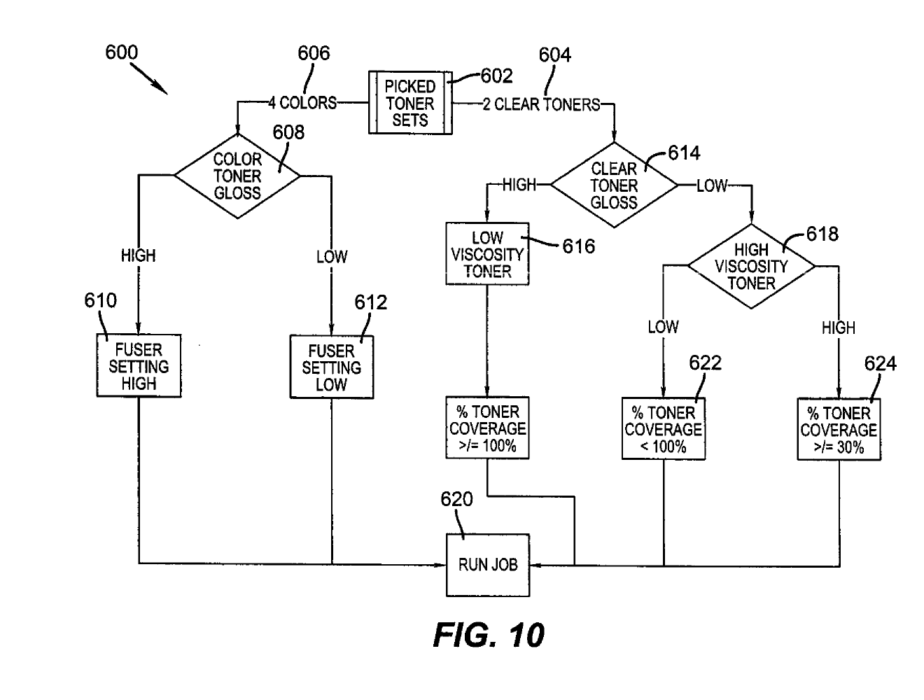

According to one embodiment, an operator of a printer or a copier determines which portion of an image the operator wishes to have at a gloss area, for example, a watermark. The location of that gloss portion is input to the copier or printer, which creates an image of a gloss enhancing toner corresponding to that watermark. The electrostatographic printer uses toners to produce a background mark that is low in gloss, or nearly matches the paper gloss using a low area mass lay-down such that the toner particles are spaced apart enough to cause light to scatter (resulting in a low gloss). FIG. 9 shows the apparent color density with respect to % toner coverage. Alternately the particles are even farther apart the paper gloss will dominate. In one instance the watermark will not be capable of exceeding the paper gloss and in another instance, by using clear toner at a high toner mass area lay-down that is equivalent to the amount of toner mass required for high color densities (at 100% coverage or greater), would result in a much higher gloss level. An electrostatographic toner lay-down process for spot glossing, or locally addressed glossing, is shown in FIG. 10. Choices can be made to have a locally addressed area higher or lower in gloss than the dominant toner images, or the remainder of the toner image, or the paper surface gloss. Using toner viscosity and variable fuser settings a controlled gloss contrast can be achieved. This process lays-down uniform layers of clear toner over the pigmented toners. FIG. 10 shows a method according to one embodiment of the present invention for basic spot glossing 600 where a decision on the toner set starts the spot glossing process 602. Such a decision may include two clear colors 604 or four colors 606 or other combinations of color and or color as well as other types of toner such as metallic or magnetic toners that could be used for spot glossing. In the examples not shown similar methods could be used and modified as needed to yield the desirable spot gloss. For spot glossing with color toners 608 it is determined if high gloss is required and if so then the Raser can be set high 610 and if a low spot gloss is desired then a low fuser setting is required 612. There are many intermediate settings that could be used but these too extremes exemplifies the process that can be used in conjunction with this present invention to produce spot glosses at the desired gloss level using the colored toners and the variable energy fuser system.

If the spot gloss is to be produced using one of two clear toner options 604 where one of two clear toners are to be used for spot glossing 614 the options are to use a low viscosity toner 616 for a high spot gloss or a high viscosity toner 618 for a low spot gloss as discussed in more detail in the examples. For the high spot gloss option the % toner coverage laid down will need to be set so that it is greater then or equal to 100% before the job is run 620. For the low spot gloss option there are two toner coverage sub options shown. In the first when the % toner coverage laid down is estimated at less then 100% then there will be a very low toner spot gloss. In the second option 624 when the % toner coverage laid down will be greater then or equal to 30% then the job is run 620 will give a higher spot gloss then the first option.

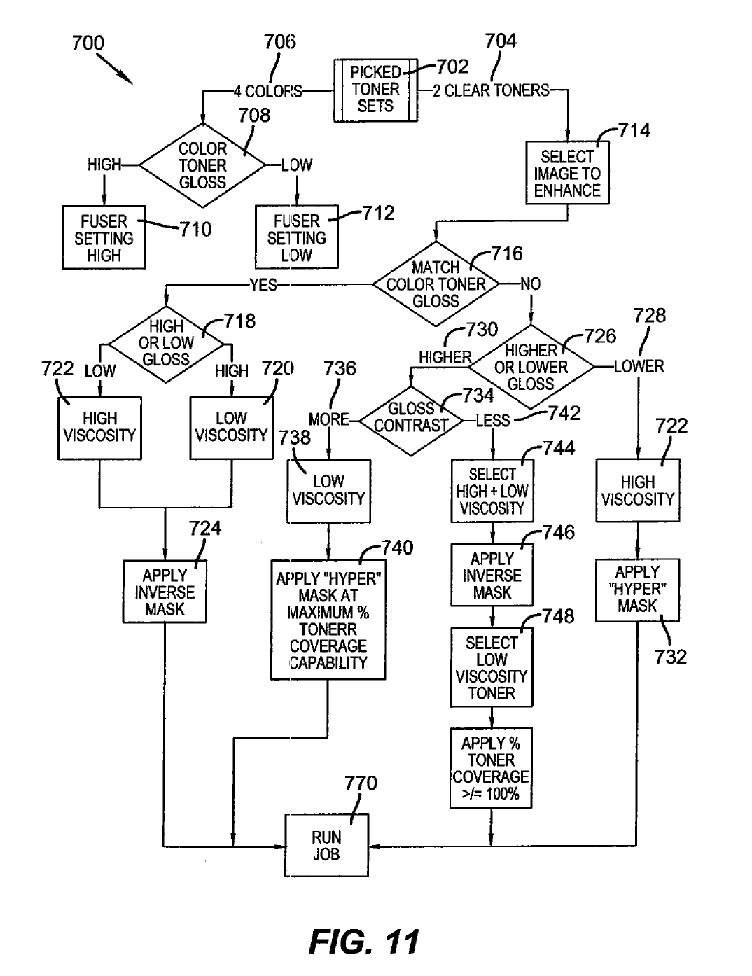

For image enhancement, image relief elimination, and toner deposit mass control (or stack height control), a process using toner viscosity, fuser settings, and toner inverse mask techniques can be used. An illustration of this process can be seen in FIG. 11.

FIG. 11 shows a method 700 according to another embodiment of the present invention for image enhancement. In this embodiment first there a decision 702 on the toner set between the use of clear colors 704 or four colors 706 to optimize the image enhancement results desired and this is done before running the final job. For enhanced imaging using color toners 708 when it is determined that a high gloss is required for the whole, or a select area, then the fuser can be set high 710 and when it is determined that a low gloss is desired then a low fuser setting is used as discussed above 712. There are possible intermediate settings that could be used but these too extremes exemplifies the process that can be used in conjunction with this present invention to produce enhanced images at the desired gloss level using the colored toners and the variable heat fuser system.

If the enhanced image is to be produced using one of two clear toner options 704 where one of two clear toners will be used then first an image is selected 714 to be enhanced and it is determined whether the user wants to match the color toner gloss 716. If the color toner gloss is to match the color toner gloss 718 then the options are to use a low viscosity toner 720 for a high enhanced image gloss or a high viscosity toner 722 for a low enhanced image gloss before applying an inverse mask of the image 724, as discussed in detail above, before running the job 770.

If the enhanced image is to be produced using one of two clear toner options 704 and it is determined whether the user does not want to match the color toner gloss 726 then is must be determined if the gloss is to be lower 728 then the rest of the image or higher then the rest of the image 730. For a gloss option where the final gloss level is higher then the enhanced image option 728, a high viscosity toner 722 is applied that will result in a lower image gloss after applying a “hyper” mask of the image 732 before running the job 770.

If the enhanced image is to be produced using one of two clear toner options 704 but it is determined that the user does not want to match the color toner gloss 726 wants a wow factor where the gloss is to be higher 730 then the decision is made on the amount of gloss contrast desired 734. For a gloss option where the final gloss contrast level is to add more contrast to the enhanced image 736, a low viscosity toner 738 is applied that will result in a greater gloss contrast after applying a “hyper” mask of the image 740 before running the job 770.

In a second option when the user does not want to match the color toner gloss 726 and desires a lower gloss contrast 742 a combination of both the low viscosity toner and the high viscosity toner can be used in specified combinations 744 to yield the desired lower contrast that differs from the image gloss before applying an inverse mask 746 of the image 724 and applying some additional viscosity toner 748 before running the job 770. When the % toner coverage for this low viscosity toner to be laid down is determined it will need to be set so that it is greater then or equal to 100% before the job is run so that the result will give the desired enhanced image with a lower contrast gloss level.

### EMBODIMENT 1

### Process A

A pigmented polyester toner being put-down, with a screen pattern, to produce a color density range correlating to approximately 1% to 20% toner coverage would produce a range of hue that would produce a background effect. FIG. 1 shows a tone scale for cyan, magenta, yellow, and black (primary colors). The independent variable is percent coverage, where 100% coverage is the maximum color density. Over this layer of pigmented toner a layer of clear polyester toner, equal to 100% toner coverage or higher that can produce the high gloss or a specific level of gloss, can be put-down. To get a specific level of gloss the clear toner flow viscosity, storage modulus, and loss modulus can be adjusted chemically, along with the amount of toner put down.

Polyester toners posses the properties to have a low melt viscosity, at fusing temperatures, for producing medium to high gloss color images of, text, graphics, and photographs. Low viscosity clear toner is the best way to achieve a medium to high gloss clear image with any level of background color hue.

### EMBODIMENT 2

### Process B

A pigmented styrene-acrylic toner being put-down, with a screen pattern, to produce a color tone scale range correlating to approximately 1% to 20% toner coverage would produce a range of hue that would produce a background effect. Over this layer of pigmented toner a layer of clear polyester toner, equal to 100% toner coverage or higher that can produce the high gloss or a specific level of gloss, can be put-down. To get a specific level of gloss the clear toner flow viscosity, storage modulus, and loss modulus can be adjusted chemically, along with the amount of toner put down.

Styrene-acrylic toner has a higher melt flow viscosity than polyester toners, which produces a low level of gloss (good for text documents). This situation, where the pigmented toner produces low gloss images, allows for a larger contrast in gloss (for the targeted area) when using a polyester clear toner for raising the gloss in the target area. The areas of the image that did not receive clear toner will have a much lower gloss.

### EMBODIMENT 3

### Process C

A pigmented polyester toner being put-down, with a screen pattern, to produce a color tone scale range correlating to approximately 1% to 20% toner coverage would produce a range of hue that would produce a background effect. Over this layer of pigmented toner a layer of clear styrene-acrylic toner, equal to 100% toner coverage or higher that can produce the high gloss or a specific level of gloss, can be put-down. To get a specific level of gloss the clear toner flow viscosity, storage modulus, and loss modulus can be adjusted chemically, along with the amount of toner put down.

Using a polyester toner for the primary colors, and styrene-acrylic toner for the background mark or image highlighting clear coat will produce an area of lower gloss, with respect to the remainder of the image. This would be considered a de-glossing process, where the gloss is lowered in a spot wise fashion with respect to the main image or images.

### EMBODIMENT 4

### Process D

For the most dramatic effect, a large differential gloss can be intentionally created. The pigmented toner can produce a low gloss by possessing relatively high melt viscosity, from 30 kPoise to ˜130 kPoise. A clear toner, with a very low melt viscosity near 2 kPoise, to be specially located on the page can produce a high gloss of around 70 units measured at a 60 degree angle, whereas the pigmented toner would produce a gloss around 10 or 20 units measured at a 60 degree angle. This contrast of approximately 50 (60 degree gloss units) produces the dramatic effect. Under the clear toner, a low color density toner coverage can be used to get the slight color hue effect, while maintaining the large gloss contrast.

The invention has been described in detail with particular reference to certain preferred embodiments thereof, but it will be understood that variations and modifications can be effected within the spirit and scope of the invention. This invention is inclusive of combinations of the embodiments described herein. References to a “particular embodiment” and the like refer to features that are present in at least one embodiment of the invention. Separate references to “am embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like are not limiting

What is claimed is:

1. A method for controlling gloss of a printed image comprising:
a. determining pigmented toner type, transparent toner type and media type;
b. determining a final desired gloss and a differential gloss of a fused image;
c. applying a color toner of the pigmented toner type onto the media substrate of the media type to form a low color density image;
d. applying the transparent toner over at least a portion of the media substrate including the toner image; and
e. fusing said toner image to form a fused print having the final desired gloss and the differential gloss of a fused image.

2. The method according to claim 1, wherein said transparent toner is applied over an entirety of said low color density toner image.

3. The method according to claim 1, wherein said transparent toner is applied over an entirety of said low color density toner image as an inverse image.

4. The method according to claim 1, wherein said transparent toner is applied in varying amounts over said low color density toner image.

5. The method according to claim 1, wherein said color toner comprises a density having a tone scale range between 1% and 20% and said transparent toner is a low viscosity clear toner having an area mass equal to at least 100% toner coverage to produce a high gloss in at least a portion of the media.

6. The method according to claim 1, wherein said color toner comprises a density having a tone scale range between 1% and 20% and one toner is a styrene-acrylic toner having a higher melt flow viscosity to produce an area of lower gloss.

7. The method according to claim 6, wherein said color toner includes said styrene-acrylic toner having a higher melt flow viscosity to produce an area of lower gloss and said clear toner includes a polyester clear toner for raising the gloss in a targeted area so that that did not receive clear toner will have a much lower gloss.

8. The method according to claim 7, wherein said color toner comprises said polyester toner having a higher melt flow viscosity between 30 and 130 kPoise and said clear toner having a lower melt flow viscosity between 1 and 30 kPoise to produce a high gloss for a high contrast.

9. The method according to claim 8, wherein said toner produces a slight color hue effect while maintaining a large gloss contrast.

10. The method according to claim 1 wherein said applying said clear toner overcoat step further comprises forming on a spot by spot basis to form a spot gloss finish.

11. The method according to claim 1 wherein said applying said clear toner overcoat further comprises detecting an original finish utilizing a densitometer to give one or more density readings of an original receiver.

12. A computer program stored in a computer-readable medium for causing a computer to execute the method according to claim 1.

13. A computer readable media for controlling gloss, differential gloss and image height of a printed image on a substrate comprising:
a code segment for obtaining a desired level of gloss and differential gloss from a user;
a code segment for reading an original image from which said printed image is to be made and calculating an image height of a color toner lay-down of said original image;
a code segment for calculating an appropriate negative mask application of transparent toner based on the image height of said color toner lay-down of said original image, said desired level of gloss and said differential gloss and said substrate; and
a code segment for applying the transparent toner over the color toner lay-down; and a code segment for fusing an image formed by the color toner lay-down and the transparent toner to form a fused print.

14. The computer readable media according to claim 13, further comprising a code segment for applying at least one of an overcoat based on said desired level of gloss and differential gloss.

15. A system for forming a multicolor image having a finish matching an original finish comprising:
a detector for detecting an original finish having reflective characteristics;
a printhead for forming a multicolor toner image on a receiver with toners of at least three different colors of toner which form various combinations of colors at different pixel locations on the receiver to form the multicolor toner image thereon using a generic color profile; and
an overcoat applicator for applying a clear toner overcoat upon the multicolor toner image based on the characteristics of said original finish.

16. The system according to claim 15 wherein the overcoat applicator applies said clear toner overcoat using said generic color profile wherein said generic color profile is based on receiver type.

17. The system according to claim 15 wherein said detector further comprises detecting the gloss differential of both said toner image and receiver.

18. The system according to claim 15 wherein said overcoat applicator further comprises forming said overcoat on a spot by spot basis to form a spot gloss finish.

20. The system according to claim 15 wherein said overcoat applicator applies said overcoat based on a table of a predetermined gloss of one or more receivers based on measured gloss levels.

21. The system according to claim 15 wherein said overcoat applicator comprises forming said overcoat in one or more shapes at one or more locations, so that one or more original finishes are rescaled in coordination with the rescaling of said multicolor image on said receiver.

21. The system according to claim 15 wherein said detector further comprises a gloss meter.

22. The system according to claim 15 further comprising an illumination source from an image scanner to detect said original finish.

23. The system according to claim 15 wherein said detector further comprises an image scanner.
